(19) United States
(12) Patent Application Publication
(10) Pub. No.: US 2026/0299680 A1
(43) Pub. Date: Oct. 1, 2026

(54) Control of Data Glasses on Board a Motor Vehicle

(71) Applicant: Bayerische Motoren Werke Aktiengesellschaft, Muenchen (DE)

(72) Inventors: Tobias BAUERNFEIND, Muenchen (DE); Wolfgang HABERL, Muenchen (DE); Alan KEIM, Hallbergmoos (DE); Manfred PAULI, Bruckberg (DE)

(21) Appl. No.: 19/629,080

(22) Filed: Mar. 26, 2026

(30) Foreign Application Priority Data
Mar. 28, 2025 (DE) 10 2025 112 269.5

(51) Int. Cl. G06F 3/01; G01P 3/36; G01P 15/00; G06F 3/0346; G06T 7/20

(52) U.S. Cl. CPC G06F 3/012; G01P 3/36; G01P 15/00; G06F 3/0346; G06T 7/20; G06T 2207/30201; G06T 2207/30268

(57) ABSTRACT

A method for controlling data glasses on board a motor vehicle includes determining a position signal of the data glasses, which indicates an orientation of the data glasses. The method includes optically scanning a person located at a driver position of the motor vehicle. The method includes determining an acceleration profile on the basis of the optical scan. The method includes determining that the position signal correlates with the acceleration profile. The method includes restricting optical content provided by the data glasses.

### CROSS REFERENCE TO RELATED APPLICATION

This application claims priority under 35 U.S.C. §119 from German Patent Application No. 10 2025 112 269.5, filed Mar. 28, 2025, the entire disclosure of which is herein expressly incorporated by reference.

### BACKGROUND AND SUMMARY

The present invention relates to the control of data glasses. In particular, the invention relates to the control of data glasses on board a motor vehicle.

Data glasses are configured to show predetermined information in a field of view of a person who wears the data glasses. The information can be overlaid in this case on a direct optical impression of the surroundings. If no information is displayed, the person can perceive their surroundings directly. Such a technology is known under the name augmented reality (AR). In contrast thereto, data glasses for virtual reality (VR) cover a field of view of the person and completely replace the optical impression with generated content. The data glasses optionally comprise a camera for scanning the optical surroundings, so that the provided content can be generated on the basis of a view of the surroundings.

A person on board a motor vehicle can wear data glasses to record any desired content. In some countries, it is permissible for a driver of the motor vehicle to wear data glasses of the augmented reality (AR) type while they are controlling the motor vehicle. However, it can be impermissible for the driver to use the data glasses for example to play back a video data stream while they are driving the motor vehicle.

Different proposals have been made to prevent content from being provided to the driver by means of the data glasses, which distracts the driver from guiding the motor vehicle. DE 10 2015 009 746 A1 relates to data glasses which have a communication connection to an electronics system located in a headrest of a driver’s seat. The data glasses can be switched off when the motor vehicle has reached a predetermined driving speed.

Known solutions for deactivating data glasses on board a motor vehicle are generally inflexible, and often a distinction is not made between data glasses of a driver and data glasses of a passenger. One object underlying the present invention is therefore to provide an improved technology for controlling data glasses on board a motor vehicle. The invention achieves this object by one or more features of the embodiments described herein.

According to at least one embodiment, a method for controlling data glasses for a person on board a motor vehicle comprises steps of determining a position signal of the data glasses, wherein the position signal indicates an orientation of the data glasses; optically scanning a person located on a driver position of the motor vehicle; determining an acceleration profile on the basis of the optical scanning; determining that the position signal correlates with the acceleration profile; and restricting optical content which is provided by means of the data glasses.

The position signal of the data glasses can comprise an acceleration along an axis (translation) and/or around an axis (rotation). The location of the data glasses can be determined by double derivation of such signals according to time.

In at least one embodiment, the position signal of the data glasses indicates an angular velocity around an axis; this value can be determined directly or provided by the data glasses without requiring separate differentiation. A profile of the angular velocity can be compared directly to an angular velocity which is determined from the optical scan. The angular velocity of the observed object can be determined with little effort from a sequence of individual images or individual scans. Axes, with respect to which the angular velocities are specified, can differ from one another; however, it can be assumed at least that vertical axes of the data glasses and of the motor vehicle are sufficiently parallel to one another. Transverse axes are generally also sufficiently parallel to one another to permit a characterizing comparison without determining the locations of the axes and adapting measured values with respect to a location error. It can thus be determined quickly with little effort whether or not the observed object comprises data glasses.

Data glasses described herein are preferably configured for augmenting an optical reality (AR) of the person wearing them. AR data glasses can be embodied significantly smaller and lighter than VR data glasses. In particular, AR data glasses can easily be confused with sunglasses or optical glasses. Therefore, it cannot necessarily be determined with certainty on the basis of an optical scan of the person whether or not the person wears data glasses. However, it can be determined by the consideration of the acceleration profile whether a head movement of the person correlates or corresponds with an orientation change of the data glasses. If this is the case, the person located on the driver position is thus wearing data glasses. In this case, the optical content displayed to the person can be restricted so as not to impermissibly distract the person from guiding the motor vehicle.

It is particularly preferred that it is determined that the scanned person wears glasses, wherein the acceleration profile of the glasses is determined. The glasses can be optically detected more easily from the optical scan and their acceleration curve can be determined with better accuracy.

Furthermore, it can be determined that the glasses comprise a lens which makes a part of the face of the person unrecognizable. The part can be considered unrecognizable if it is concealed by the lens or darkened sufficiently strongly. This is regularly the case when the person wears sunglasses or data glasses. Clear glasses, which the person can wear because of a visual defect, for example, can be distinguished from data glasses, so that no restriction of content takes place when the driver wears conventional glasses.

According to at least one embodiment, it can be determined that only a single person is located on board the motor vehicle. In this case, it can be determined that this person must be a driver of the motor vehicle, so that the optical content of the data glasses is restricted. A differentiated observation can first take place when it is determined that multiple people are located on board the motor vehicle. Data glasses worn by a person on the driver’s seat can therefore be restricted in the provided content, while data glasses worn by a person at another position in the motor vehicle can remain unrestricted with respect to the displayed content.

It can be established that multiple pairs of data glasses are located on board the motor vehicle. In particular, multiple people each having data glasses can be located on board the motor vehicle. It can be found out by means of a seat identification, for example, where on board the motor vehicle a person is located. The seat identification can use, for example, an occupancy sensor, a belt sensor of a safety belt, or a camera for scanning the position as sensors. Which of the people on board the motor vehicle wear data glasses can be determined on the basis of an optical scan of the relevant position on board. If only one pair of data glasses is located on board, it can be assigned without further determinations to a driver and content displayed by it can be restricted.

The data glasses are preferably configured to provide optical content in the correct location with respect to the motor vehicle. For a person wearing the data glasses, the displayed content can appear to stand still with respect to the motor vehicle, even if they move their head in relation to the motor vehicle. For this purpose, an orientation of the data glasses with respect to the motor vehicle can be determined on the basis of the position signal of the data glasses and a position signal of the motor vehicle. Both position signals can each comprise up to six degrees of freedom, which can be offset against one another accordingly in the manner of a vector subtraction in order to determine the orientation of the data glasses with respect to the motor vehicle. To restrict the optical content, the position signal of the motor vehicle can be withheld, so that it does not reach the data glasses.

In the absence of the position signal of the motor vehicle, the data glasses can end the output of content. In particular, content which is related to the motor vehicle may no longer be displayed. Optionally, different content which is related, for example, to the surroundings of the motor vehicle, can continue to be displayed. Such a notification can comprise, for example, information with respect to an object outside the motor vehicle, such as a notification of a parking space, a building, a body of water, or an elevation.

The provided content is preferably restricted such that it is suitable for a driver of the motor vehicle. It is thus possible to differentiate between contents which the driver – and possibly another person on board the motor vehicle – is supposed to see while guiding the motor vehicle and those which they are not supposed to see – but which could possibly be seen by another person on board the motor vehicle. For example, a notification of a driving speed or another parameter of the motor vehicle can be provided to the driver, while a video data stream, for example from an entertainment film or a game, is not displayed to the driver.

Furthermore preferably, it is determined that the motor vehicle moves at a predetermined minimum speed before the content provided by means of the data glasses is restricted. It is thus possible to reflect that the driver is hardly challenged in guiding the motor vehicle below the minimum speed, so that a possible distraction, for example by a video data stream, is permissible. In some countries, it is permissible for the driver of a motor vehicle to view a video data stream below a speed of approximately 5 km/h.

According to at least one embodiment, a device for controlling data glasses on board a motor vehicle comprises an interface for receiving a position signal of the data glasses, wherein the position signal indicates an orientation of the data glasses; a scanning apparatus for optically scanning a person located on a driver position of the motor vehicle; and a processing apparatus. The processing apparatus is configured to determine an acceleration profile on the basis of the optical scan; to determine a correlation of the position signal with the acceleration profile; and to restrict optical content provided by means of the data glasses.

The processing apparatus is preferably configured to partially or completely carry out a method described herein. For this purpose, the processing apparatus can be embodied as electronic and can comprise, for example, an integrated circuit, a programmable logic module, or a programmable microcomputer. The method can be implemented in the form of a configuration or as a computer program product having program code means for the processing apparatus. The configuration or the computer program product can be stored on a computer-readable data carrier. Features or advantages of the method can be transferred to the device or vice versa.

According to at least one embodiment, a motor vehicle comprises a device described herein. The motor vehicle can in particular comprise a passenger vehicle. Elements of the device can be comprised by the motor vehicle. For example, the motor vehicle can have an interior camera which can be used as a scanning apparatus for the device.

According to at least one embodiment, a system is proposed which comprises a device described herein and data glasses. The data glasses comprise a position sensor for providing a position signal and an output apparatus for providing optical content to a wearer of the data glasses. The output apparatus is of an optical nature and can show optical information actively or passively in a field of view of the wearer. The data glasses are configured to determine their orientation with respect to the position signal and a position signal of a surrounding motor vehicle and to provide the content with respect to the determined orientation.

It is to be noted that the data glasses can have their own processing apparatus. The processing apparatus can be integrated with the data glasses or detached therefrom. In one embodiment, a mobile device, for example a smart phone, can be used as the detached processing apparatus.

The invention will now be described in more detail with reference to the appended drawings.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 illustrates a system; and

FIG. 2 illustrates a flow chart of a method.

### DETAILED DESCRIPTION OF THE DRAWINGS

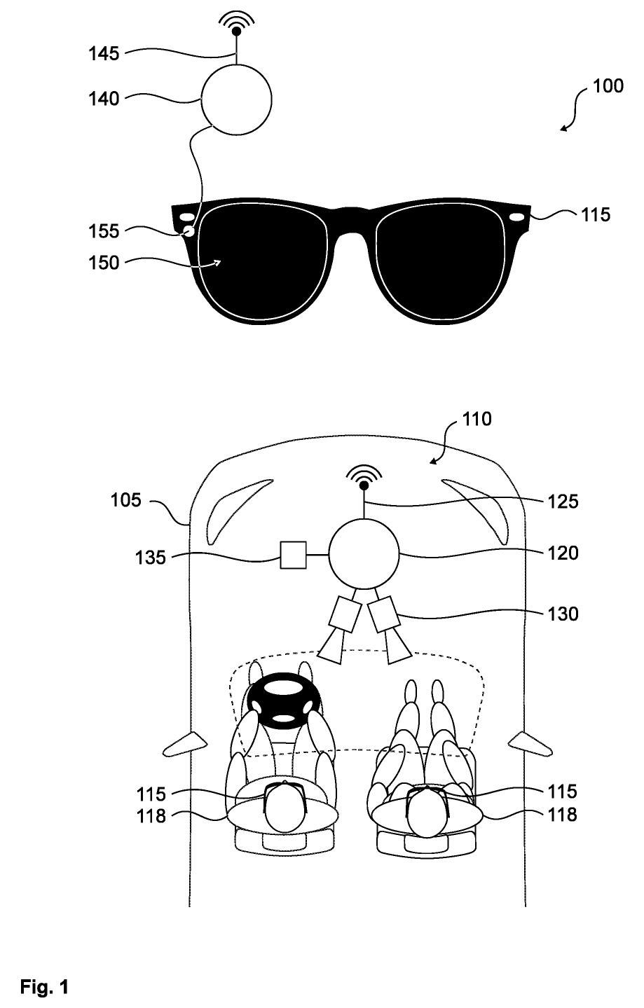

FIG. 1 shows a schematic representation of a system 100 having a motor vehicle 105, a device 110 on board the motor vehicle 105, and data glasses 115. The data glasses 115 are shown in a dedicated view in an upper area. A schematic top view of the motor vehicle 105 is shown in a lower area.

One or more people 118, each of whom can wear data glasses 115, can be located on board the motor vehicle 105. One of the people 118 can be a driver, another a front passenger or passenger. Data glasses 115 can provide predetermined content to a wearer 118, which is overlaid on a direct optical impression of the surroundings. To avoid displayed information being overlaid on directly perceptible information for a driver 118 of the motor vehicle 105 or distracting the driver 118, it is proposed to restrict or switch off content which is provided by means of data glasses 115 worn by a driver 118 of the motor vehicle 105.

The device 110 comprises a processing apparatus 120, an interface 125, and an optical scanning apparatus 130. Furthermore, a position sensor 135 is preferably provided, which provides a position signal that indicates an orientation of the motor vehicle 105. The position sensor 135 can in particular comprise an acceleration sensor (inertial measurement unit, IMU). The scanning apparatus 130 is configured to scan one or more positions on board the motor vehicle 105, at which people 118 can be located. In particular, the scanning apparatus 130 is configured to scan a position which is provided for a driver 118 of the motor vehicle 105. Multiple scanning apparatuses 130 can also be provided, as schematically indicated in FIG. 1. A scanning apparatus 130 can be used to check whether a person 118 is located at a predetermined position on board the motor vehicle 105. Different numbers of positions or seats can be provided in different seat rows.

The interface 125 is configured to enable communication between the device 110 and the data glasses 115. The interface 125 is preferably embodied as wireless. A wired or a mixed wireless and wired transmission is likewise possible. The data glasses 115 comprise a processing apparatus 140, an interface 145, an output apparatus 150, and preferably a position sensor 155. Solely by way of example, the processing apparatus 140 is shown detached from the data glasses 115, an integrated embodiment is likewise possible.

The position sensor 155 is configured to determine an orientation of the data glasses 115 in space. A position can optionally also be determined, so that a pose is present. The interface 145 is configured for communication with the interface 125 of the device 110. A connection between the processing apparatus 140 and the data glasses 115 can be wired or wireless.

It is proposed to restrict only contents which can be provided by means of data glasses 115 worn by a driver 118 of the motor vehicle 105. Contents which are provided by means of other data glasses 115 on board the motor vehicle 105 can be unrestricted, in contrast. Content can in particular be provided on the part of the motor vehicle 105, furthermore preferably on the part of the device 110. Different sources can be used for this purpose, which provide different types of information. A first source can provide information, for example, which indicates a driving status or a navigation destination of the motor vehicle 105 and which is generally acceptable for display to a driver 118 of the motor vehicle 105. A second source can provide information which is not to be provided to the driver 118 as long as the motor vehicle 105 is traveling. Such information can comprise, for example, a video data stream or a complex or elaborate animation. In the reverse direction, a position signal of the position sensor 155 can be provided from the data glasses 115 to the device 110. A technology described herein is preferably carried out on the part of the device 110. However, it is also possible to carry out parts of the technology on the part of the data glasses 115.

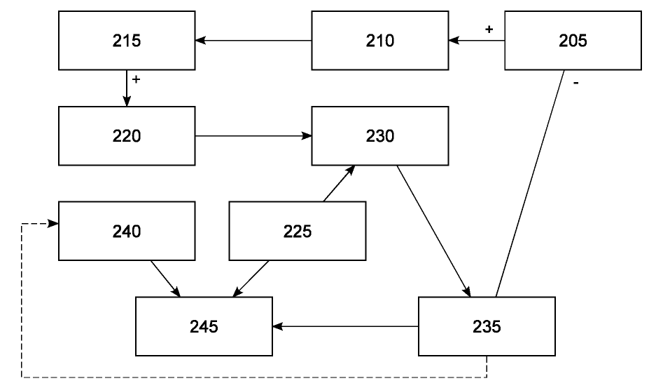

FIG. 2 shows a flow chart of a method 200 for controlling data glasses 115 on board a motor vehicle 105. In a step 205, it is determined whether more than one person 118 is located on board the motor vehicle 105. Positions at which people 118 can be located can be scanned for this purpose. In particular, a seat occupancy system can determine which seat on board the motor vehicle 105 is occupied by a person 118. Optionally, it can also be determined whether more than one pair of data glasses 115 is located on board the motor vehicle 105. For this purpose, for example, position signals can be received from position sensors 155 of different pairs of data glasses 115.

If multiple people 118 or multiple pairs of data glasses 115 are to be assumed on board the motor vehicle 105, in a step 210, a position on board the motor vehicle 105, which is intended for a driver 118, can be optically scanned. In a step 215, it can be checked whether a person 118 is located on this position and whether the person 118 wears glasses, which possibly comprises data glasses 115. This can be the case if a section of the face of the person 118 in the area of their eyes is concealed or made unrecognizable by a lens of glasses, which the person 118 wears.

In a step 220, an acceleration profile of the glasses 115 of the person 118 on the driver position can be determined on the basis of the optical scan. For this purpose, the glasses 115 can be tracked in a sequence of images or in a recorded video data stream. The acceleration profile can be determined along predetermined axes with respect to the motor vehicle 105 or with respect to the surroundings.

In a step 225, position signals from all pairs of data glasses 115 on board the motor vehicle 105 can be captured. Position signals are preferably determined in each case by means of a position sensor 155 of data glasses 115 and transmitted via the interfaces 145 and 125 to the device 110.

In a step 230, the acceleration profile can be compared with the position signals of the data glasses 115. If an equivalence or correlation is shown between the determined acceleration profile and one of the position signals, a pair of data glasses 115 which is assigned to the position signal is thus found. A person 118 located on the driver position of the motor vehicle 105 wears the data glasses 115 found.

In a step 235, contents which are provided by means of these data glasses 115 can be restricted. For example, information from a first source, which is permissible for display to the driver 118, can continue to be provided, while information which originates from a second data source which is not permissible for display to a driver 118 of the motor vehicle 105 can be switched off. All contents can also be switched off for the data glasses 115 of the driver 118.

The data glasses 115 typically operate such that their provided contents are output with respect to their orientation. For this purpose, in a step 240, a position signal of the motor vehicle 105 can be determined, in particular on the basis of a position signal of the position sensor 135. In a step 245, the position signal of the motor vehicle 105 can be offset against a position signal of the relevant data glasses 115. In particular, an orientation of the data glasses 115 with respect to the motor vehicle 105 can be determined in the manner of a vector subtraction. Content to be displayed with respect to the motor vehicle 105 can then be output on the basis of the determined orientation by means of the output apparatus 150 to the person 118.

In one embodiment, the output of contents is completely suppressed in that the provision of the position signal of the motor vehicle 105 to the data glasses 115 is suppressed, as indicated by a dashed line in FIG. 2. The data glasses 115 or the processing apparatus 140 thereof can no longer use the absent position signal of the motor vehicle 105 to determine the orientation in relation to the motor vehicle 105 and therefore stop the output.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### REFERENCE NUMERALS

100 system

105 motor vehicle

110 device

115 data glasses

118 person

120 processing apparatus

125 interface

130 scanning apparatus

135 position sensor

140 processing apparatus

145 interface

150 output apparatus

155 position sensor

200 method

205 more than one person/pair of data glasses on board?

210 optically scan driver position

215 person with potential data glasses detected?

220 determine acceleration profile of the glasses

225 capture position signals from data glasses on board

230 compare acceleration profile and position signal

235 restrict or switch off content

240 capture position signal of the motor vehicle

245 offset signals, present contents

What is claimed is:

1. A method for controlling data glasses on board a motor vehicle, wherein the method comprises:
determining a position signal of the data glasses, wherein the position signal indicates an orientation of the data glasses;
optically scanning a person located on a driver position of the motor vehicle;
determining an acceleration profile on the basis of the optical scan;
determining that the position signal correlates with the acceleration profile; and
restricting optical content provided by the data glasses.

2. The method of claim 1,
wherein the position signal describes an angular velocity of the data glasses,
wherein an angular velocity of an observed object is determined based on the optical scan, and
wherein the correlation is determined on the basis of a comparison of profiles of the angular velocities.

3. The method according of claim 1,
wherein it is determined that the scanned person wears the glasses,
wherein the acceleration profile is of the glasses, and
wherein it is determined that the glasses comprise a lens which makes a part of the face of the person unrecognizable.

4. The method of claim 1,
wherein it is determined that multiple people are located on board the motor vehicle, and/or
wherein it is determined that multiple pairs of data glasses are located on board the motor vehicle.

5. The method of claim 1,
wherein optical content is provided by the data glasses with respect to an orientation determined based on the position signal of the data glasses and a position signal of the motor vehicle,
wherein the restriction comprises withholding the position signal of the motor vehicle, and
wherein the data glasses are configured to end the output of content if no position signal of the motor vehicle is present.

6. The method of claim 1,
wherein the content is restricted such that it is suitable for a driver of the motor vehicle, and/or
wherein the content is divested of information which can distract a driver from guiding the motor vehicle; and/or
wherein the restricted content comprises information which is beneficial to guidance of the motor vehicle.

7. The method of claim 1, wherein it is determined that the motor vehicle moves at a predetermined minimum speed.

8. A device for controlling data glasses on board a motor vehicle, wherein the device comprises:
an interface that receives a position signal of the data glasses, wherein the position signal indicates an orientation of the data glasses;
a scanning apparatus that optically scans a person located in a driver position of the motor vehicle; and
a processing apparatus that determines an acceleration profile based on the optical scan, determines a correlation of the position signal with the acceleration profile, and restricts optical content provided by the data glasses.

9. A motor vehicle, comprising:
the device of claim 8.

10. A system, comprising:
the device of claim 8; and
data glasses comprising:
a position sensor that provides the position signal, and
an output apparatus that provides the optical content to the data glasses, wherein the data glasses determine their orientation with respect to the position signal and a position signal of a surrounding motor vehicle, and provide the content with respect to the determined orientation.
